(19) United States
(12) Patent Application Publication
(10) Pub. No.: US 2007/0119297 A1
(43) Pub. Date: May 31, 2007

(54) LINEAR HYDRAULIC AMPLIFIER

(75) Inventor: Philip J. Mott, Dryden, NY (US)

Correspondence Address: BORGWARNER INC.;c/o Brown & Michaels, PC, 400 M&T Bank Building, 118 N. Tioga Street, Ithaca, NY, 14850, US

(73) Assignee: BorgWarner Inc., Auburn Hills, MI (US)

(21) Appl. No.: 11/459,058

(22) Filed: Jul. 21, 2006

Related U.S. Application Data
(60) Provisional application No. 60/701,204, filed on Jul. 21, 2005.

(51) Int. Cl. F15B 9/10

(52) U.S. Cl. 91/374

(57) ABSTRACT

A positioner for an internal combustion engine in which a piston is positioned by a vibrational work piece, establishing a position set point of the vibrational work piece relative to a stationary work piece or hollow sleeve. The piston, when acted upon by oscillatory vibrations of the vibrational work piece moves towards the position set point with energy provided by cyclical vibrations of the vibrational work piece. The movement of the piston selectively directs fluid to flow from a first chamber to a second chamber and vice versa, moving the control sleeve relative to the piston, such that the position set point is obtained when the piston is centered or at null position within the control sleeve. The vibrational work piece may be moved relative to the stationary work piece.

### REFERENCE TO RELATED APPLICATIONS

This application claims an invention which was disclosed in Provisional Application No. 60/701,204, filed Jul. 21, 2005, entitled “LINEAR HYDRAULIC AMPLIFIER”. The benefit under 35 USC §19(e) of the United States provisional application is hereby claimed, and the aforementioned application is hereby incorporated herein by reference.

### BACKGROUND OF THE INVENTION

1. Field of the Invention

The invention pertains to the field of linear positioners. More particularly, the invention pertains to a linear hydraulic amplifier positioner.

2. Description of Related Art

Hydraulic amplifiers of the prior art are often used to output an amplified force based on a force received.

One example of a hydraulic force amplifier is Warnecke et al.'s U.S. Pat. No. 4,516,470 which discloses an unbalanced hydraulic valve assembly. The assembly has a housing with a bore which receives an amplifier piston. One end of the bore is closed by a plug and a pressure piston and the opposite end of the bore is closed by seals and a separating piston. The amplifier piston consists of an outer guide sleeve, an inner control sleeve, and a control plunger. The outer guide sleeve and the inner control sleeve each have two control ports that may line up depending on the position of the control plunger. The control plunger is connected at one end to a reaction piston attached to a brake pedal and to a piston base member attached to a separating piston at the other end of the control plunger. The separating piston is connected to the brake master cylinder. A fluid chamber is formed between the housing and the amplifier piston and leads to a return conduit or sump. Another fluid chamber is formed between the amplifier piston and the end of the bore sealed with the plug and leads to a pressure conduit or pressurized supply. When pressure is applied to the reaction piston, the control plunger is moved to a position such that at least one of the control ports opens, allowing fluid communication between the pressure conduit and the fluid chamber formed between the amplifier piston and the end of the bore sealed with the plug. Likewise, as the amplifier piston continues to move towards the separating piston, a second control port opens and fluid in the chamber formed between the housing and the amplifier piston exits through the return conduit.

Another example of a hydraulic amplifier is Leineweber et al.'s U.S. Pat. No. 4,379,423, which discloses a housing provided with pressure and return conduits, an amplifier piston and a control slide. The piston is slidably received in a bore of the housing and has a blind bore for receiving the control slide. The piston and the control slide move together as a unit, free of pressure equalization. The unit has two sets of passages for selectively placing a face of the piston into communication with the pressure and return conduits, depending on the position of the slide in the bore of the piston.

All of the above examples of prior art hydraulic amplifiers require hydraulic pressure and return conduits. Therefore, there is a need for an amplifier device that is self-contained.

### SUMMARY OF THE INVENTION

In a first embodiment, a piston is positioned by a vibrational work piece, establishing a position set point of the vibrational work piece relative to a stationary work piece or hollow sleeve. The piston, when acted upon by oscillatory vibrations of the vibrational work piece, moves towards the position set point with energy provided by cyclical vibrations of the vibrational work piece. The movement of the piston selectively directs fluid to flow from a first chamber to a second chamber and vice versa, moving the control sleeve relative to the piston, such that the position set point is obtained when the piston is centered or at null position within the control sleeve. The vibrational work piece may be moved relative to the stationary work piece.

In another embodiment, the piston is positioned by some external means, preferably a small electric actuator, a vacuum source, or solenoid, establishing a position set point of the vibrational work piece relative to the stationary work piece. When the piston is acted upon by oscillatory vibrations, the piston will move towards the position set point with energy provided by the cyclical vibrations. The movement of the piston selectively directs fluid to flow from a first chamber to a second chamber or vice versa, moving the control sleeve and in this case, the vibrational work piece relative to the piston, such that the position set point is obtained when the piston is centered or at null within the control sleeve.

### BRIEF DESCRIPTION OF THE DRAWINGS

FIG. 1 shows a positioner of a first embodiment in a first position used with a tensioner.

FIG. 2 shows a positioner of a first embodiment in a second position used with a tensioner.

FIG. 3 shows a positioner of a first embodiment in a third position used with a tensioner.

FIG. 4 shows a positioner of a second embodiment in a first position.

FIG. 5 shows a positioner of a second embodiment in a second position.

FIG. 6 shows positioner of a second embodiment in a third position.

### DETAILED DESCRIPTION OF THE INVENTION

The positioner of the present invention utilizes vibrational energy for force amplification. The positioner may be used in any actuation system that has a cyclical force that is at least partially reversed. The positioner of the present invention does not need an external power source since oil is circulated internally to the positioner, which is self-contained.

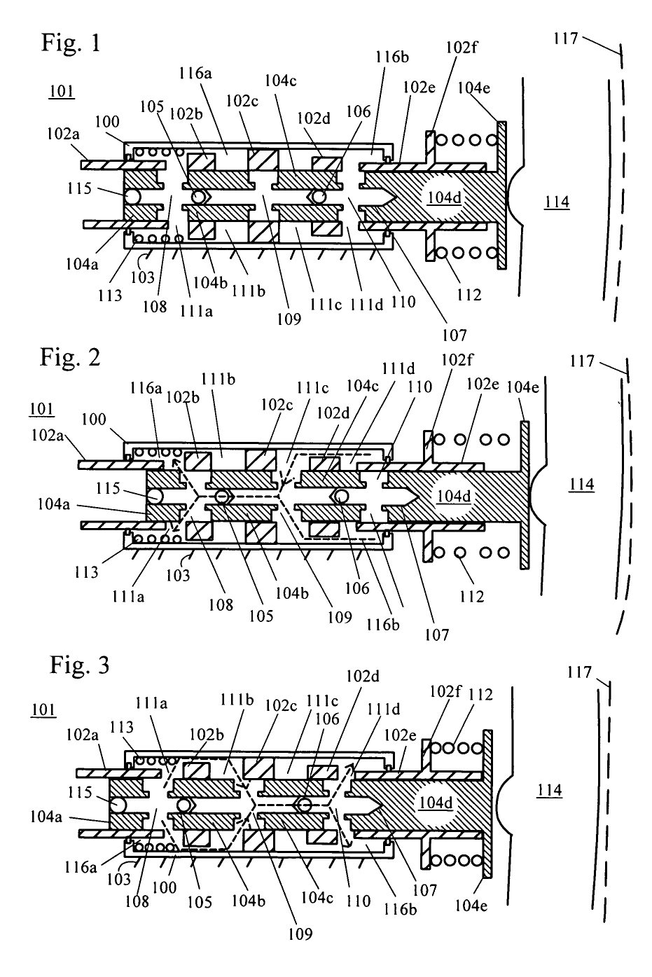

In a first embodiment, shown in FIGS. 1 through 3, the positioner 101 is used with a vibrational work piece, such as a tensioner arm 114. The positioner has a hollow sleeve 100 fixed to the engine block 103 or a stationary piece. The hollow sleeve has two open ends for slidably receiving a control sleeve 102. The control sleeve 102 has multiple passages or ports 111a, 111b, 111c, 111d defined by control sleeve portions 102a, 102b, 102c, 102d. Port 111a is defined between control sleeve portions 102a and 102b. Port 111b is defined between control sleeve portions 102b and 102c. Port 111c is defined between control sleeve portions 102c and 102d. Port 111d is defined between control sleeve portions 102d and 102e. The length of the control sleeve 102 is greater than the length of the hollow sleeve 100, and the control sleeve portion 102e at one end is only partially received within the hollow sleeve 100. A tab 102f formed on the control sleeve portion 102e acts as a stop and prevents the control sleeve 102 from sliding too far the left in the figures. The control sleeve 102 slidably receives a piston 104. The piston 104 and the control sleeve 102 close off the two open ends of the hollow sleeve 100, forming fluid chambers 116a, 116b.

The piston 104 includes a plurality of lands 104a, 104b, 104c, and 104d. The land 104d extends a length beyond the hollow sleeve 100 and the control sleeve 102 and has a flat portion 104e, which contacts the vibrational work piece 114, which is shown as a tensioner arm in FIGS. 1 through 3. A central bore 107 runs a portion of the length of the piston 104. Within the central bore 107 are check valves 105, 106, allowing fluid to flow in one direction and blocking the flow of fluid in an opposite direction through the bore 107. Extending from the bore 107 to fluid chambers 116a and 116b are a first passage 108, a central passage 109, and a second passage 110, defined by the lands 104a, 104b, 104c, and 104d of the piston. The first passage 108 is defined between lands 104a and 104b. The central passage 109 is defined between lands 104b and 104c. The second passage 110 is defined between lands 104c and 104d. When the passages 108, 109 and 110 are aligned with the ports 111a, 111b, 111c, or 111d, the first passage 108 connects the bore 107 in the piston 104 to the first fluid chamber 116a, the central passage 109 connects the bore 107 in the piston 104 to the first fluid chamber 116a or the second fluid chamber 116b, and the second passage 110 connects the bore 107 in the piston 104 to the second fluid chamber 116b. A plug 115 is present at the end of land 104a to seal off the end of the bore 107.

A connecting spring 112 is present between the tab 102f of the control sleeve 102 and the flat portion 104e of the piston land 104d, linking the motion of the piston 104 with the control sleeve 102. The central position or null position of the piston 104 relative to the fixed hollow sleeve 102 is based on the connecting spring resting point.

A spring 113 is also present within the first fluid chamber 116a between the hollow control sleeve 102 and control sleeve portion 102b for preventing the control sleeve 102 from bottoming out and for aiding in returning the control sleeve 102 to a central position.

The first fluid chamber 116a is separated from the second fluid chamber 116b formed between the hollow sleeve 100 and the control sleeve 102 and piston 104 by control sleeve portion 102c and check valve 105 in the bore 107 of the piston 104 in the central position shown in FIG. 1. The second fluid chamber 116b is separated from the first chamber 116a formed between the hollow sleeve 100 and the control sleeve 102 and piston 104 by control sleeve portion 102c and check valve 106 in the bore 107 of the piston 104 in the central position or null position shown in FIG. 1.

In this embodiment, the piston 104 is positioned by the vibrational work piece 114, establishing a position set point of the vibrational work piece 114 relative to the stationary work piece or hollow sleeve 102. The piston 104, when acted upon by oscillatory vibrations of the vibrational work piece 114, will move towards the position set point with energy provided by cyclical vibrations of the vibrational work piece 114. The movement of the piston 104 selectively directs fluid to flow from a first chamber 116a to a second chamber 116b and vice versa, moving the control sleeve 102 relative to the piston 104 such that the position set point is obtained when the piston 104 is centered or at null position within the control sleeve 102.

FIG. 1 shows the piston 104 in a central or null position relative to the hollow sleeve or stationary piece 103. In this position, fluid is prevented from moving from the first fluid chamber 116a to the second fluid chamber 116b or vice versa. The first passage 108 is aligned with control sleeve port 111a, however, fluid is prevented from entering and traveling through the bore 107 in the piston 104 from the first passage 108 by check valve 105. The central passage 109 is blocked by control sleeve portion 102c. The control sleeve portion 102c also prevents fluid from traveling from the first chamber 116a to the second chamber 116b and vice versa. The second passage 110 is aligned with control sleeve port 111d, however, fluid is prevented from entering and traveling through the bore 107 in the piston 104 from the second passage 110 by check valve 106. The force of the connecting spring 112 and spring 113 is substantially equal to the force exerted by the vibrational work piece 114.

In FIG. 2, the force of the vibrational work piece 114 is less than the spring force of the connecting spring 112, establishing a position set point of the vibrational work piece 114. The piston 104 is moved towards the tensioner arm, biasing the tensioner arm 114 in the Figure, towards the chain 117. In order to recenter the piston 104 relative to the hollow sleeve 100 and obtain the position set point, fluid circulates from the second chamber 116b to the first chamber 116a. Prior to recentering of the piston 104, control sleeve ports 111a, 111c, and 111d are open and control sleeve port 111b is blocked by piston land 104b. Control sleeve port 111c is open to the central passage 109, control sleeve port 111d is open to the second passage 110, and control sleeve port 111a is open to the first passage 108. Fluid in the second chamber 116b, due to the movement and position of the piston 104, flows from the second chamber 116b through the control sleeve port 111c and central passage 109 to the bore 107 in the piston 104. From the central bore 107, fluid flows through check valve 105 into the first passage 108 and to the first chamber 116a. The movement of the fluid from the second chamber 116b to the first chamber 116a moves the control sleeve 102, towards the tensioner arm 114, following the piston 104, resulting in the piston being in a centered position, relative to the stationary piece or hollow sleeve 100 as shown in FIG. 1, obtaining the position set point and in this case, moving the vibrational work piece 114 relative to the stationary piece 103. With the control sleeve 102 following the piston position 104, the vibrational force of the vibrational work piece 114, for example the tensioner arm 114, is amplified.

In FIG. 3, the force of vibrational work piece 114 is greater than the spring force of the connecting spring 112, establishing a position set point of the vibrational work piece 114. In this example, the piston 104 is moved away from the tensioner arm 114 and chain 117. In order to recenter the piston 104 relative to the hollow sleeve 100 and obtain the position set point, fluid circulates from the first fluid chamber 116a to the second fluid chamber 116b. Prior to recentering of the piston 104, control sleeve ports 111a, 111b, and 111d are open and control sleeve port 111c is blocked by piston land 104c. Control sleeve port 111b is open to the central passage 109, control sleeve port 111a is open to the first passage 108, and control sleeve port 111d is open to the second passage 110. Fluid in the first chamber 116a, due to the movement and position of the piston 104, flows from the first chamber 116a through the control sleeve port 111b and the central passage 109 to the bore 107 in the piston 104. From the central bore 107, fluid flows through check valve 106 into the second passage and the second chamber 116b. The movement of the fluid from the first chamber 116a to the second chamber 116b, moves the control sleeve away from the tensioner arm 114, following the movement of the piston 104, resulting in the piston 104 being in a centered position relative to the stationary piece or hollow sleeve 100 as shown in FIG. 1, obtaining the position set point, moving the vibrational work piece slightly towards the tensioner arm. With the control sleeve 102 following the piston position 104, the vibrational force of the vibrational work piece 114, for example the tensioner arm is amplified.

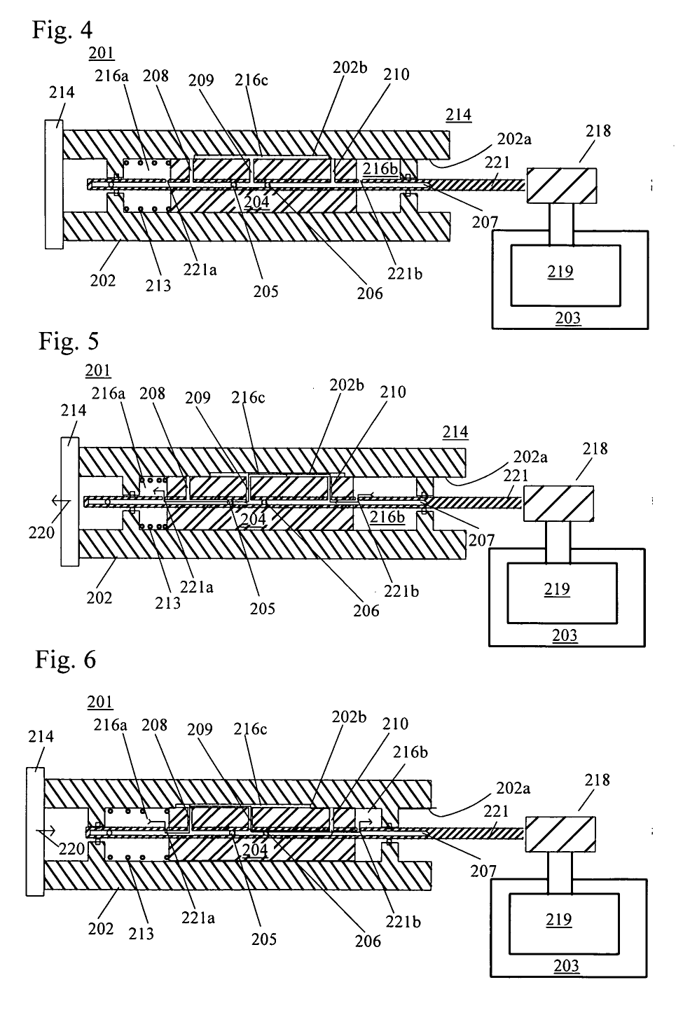

A positioner of a second embodiment used with external means, shown here as a motor driven worm gear 218, 219, is shown in FIGS. 4 through 6. The positioner 201 has a hollow control sleeve 202 with two open ends closed off be seals and an actuating rod 221 at either end forming a chamber. A piston 204 is slidably received within the hollow control sleeve 202 and is coupled to the actuating rod 221, separating the chamber into a first fluid chamber 216a, a second fluid chamber 216b, and a third fluid chamber 216c. The hollow control sleeve 202 contacts a vibrational work piece 214, such that movement of the hollow control sleeve 202 moves the vibrational work piece 214.

One end of the actuating rod 221 is coupled to and driven by a worm gear 218 which is driven by a motor 219 coupled to a stationary piece or the engine block 203. The other end of the actuating rod 221 is received and irreversibly coupled to the piston 204. The end of the actuating rod irreversibly coupled to the piston 204 has a bore 207 extending a length of the actuating rod 221. Within the bore 207, centered in the piston 204, are check valves 205, 206 which allow fluid in one direction and block the flow of fluid in an opposite direction.

The first fluid chamber 216a is defined between an end of the piston 204, the inner circumference 202a of the hollow control sleeve 202, the seals formed as part of the control sleeve 202, and the actuating rod 221. The second fluid chamber 216b is defined between the other end of the piston 204, the inner circumference 202a of the hollow control sleeve 202, the seals 220, and the actuating rod 221. The third fluid chamber 216c is defined between the piston 204 and a groove 202b on the inner circumference 202a of the hollow control sleeve 202 extending a length. The circulation of fluid between the fluid chambers 216a, 216b, 216c moves the hollow control sleeve 202 and thus the vibrational work piece 214. Passages 208, 209, 210 within the piston 204 allow fluid to pass between fluid chambers 216a, 216b, 216c. A first piston passage 208 extends from the bore 207 to the outer circumference of the piston. A central piston passage 209 extends from the bore 207 to the third fluid chamber 216c. A second piston passage 210 extends from the bore 207 to the outer circumference of the piston. Fluid from the first fluid chamber 216a, when allowed, may flow through a first passage 221a in the actuating rod 221 to the central bore 207 and the first piston passage 208. Fluid from the second fluid chamber 216b, when allowed may flow through a second passage 221b in the actuating rod 221 to the central bore 207 and the second piston passage 210.

A spring 213 is present in the first fluid chamber to bias the piston towards the worm gear. The resting spring rate of spring 213 is such that against an established set force generated by the worm gear driven by a motor, the piston is maintained in a central or null position relative to the hollow control sleeve 202 as shown in FIG. 4. In other words, the resting spring rate of spring 213 is substantially equal to the established set force of the motor driven worm gear.

In this embodiment, the piston 204 is positioned by some external means 218, 219, preferably a small electric actuator, a vacuum source, or a solenoid, establishing a position set point of the vibrational work piece 214 relative to the stationary work piece 203 through the piston 204. The external means 218, 219 moves the piston 204 towards the position set point. The movement of the piston 204 selectively directs fluid to flow from a first chamber 216a to a second chamber 216b or vice versa, moving the control sleeve 202 and in this case, the vibrational work piece 214 relative to the piston 204, such that the position set point is obtained when the piston 204 is centered or at null within the control sleeve 204.

In the null or central position, shown in FIG. 4, fluid is prevented from moving from the first fluid chamber 216a to the second fluid chamber or to the third fluid chamber 216c and vice versa. More specifically, the passages 221a, 221b in the actuating rod are open to communicate with the first fluid chamber 216a and the second fluid chamber 216b, the central passage 209 is in communication with the third fluid chamber 216c, and the first piston passage 208 and the second piston passage 210 are blocked by the inner circumference 202a of the hollow control sleeve 202. Fluid is prevented is prevented from entering the central piston passage 209 through the bore 207 from the first fluid chamber 216a or the second fluid chamber 216b by the check valves 205, 206 in the bore 207. The force of the spring 213 is substantially equal to the force exerted by the motor driven worm gear.

In FIG. 5, the force of the motor driven worm gear 218 on the actuating rod 221 fixed to the piston 204 is greater than the force of spring 213 on the opposite end of the piston 204, establishing a position set point of the vibrational work piece 214 through the piston 204. The piston 204 is moved to the left in the figure. The movement of the piston 204 causes fluid to circulate from the second fluid chamber 216b to the first fluid chamber 216a, moving the control sleeve 202 in the direction of arrow 220, resulting in the piston 204 being moved back to a centered position as shown in FIG. 4 obtaining the position set point and moving the vibrational work piece 214 in the direction of arrow 220 to a new position. Prior to the piston 204 recentering, the first piston passage 208 is blocked by the inner circumference 202a of the hollow sleeve 202, the second piston passage 210 is open to the third fluid chamber 216c, and the central piston passage 209 is open to the third fluid chamber 216c and the second piston passage 210. Fluid in the second fluid chamber 216b, due to the movement and position of the piston 204, flows from the second fluid chamber 216b through the second passage 221b in the actuating rod 221 through the bore 207 to the second piston passage 210. From the second piston passage 210, fluid moves into the third fluid chamber 216c and into the central piston passage 209. From the central piston passage 209, fluid moves into the bore 207 and through check valve 205 to the first fluid chamber 216a through the first passage 221a of the actuating rod 221. The movement of the fluid from the second fluid chamber 216b to the first fluid chamber 216a moves the control sleeve 202, and thus the vibrational work piece 214 in the direction of arrow 220 to a new position relative to the stationary piece 203, following the position of the piston 204 and amplifying the small force generated by the worm gear 218 and the motor 219. Once the control sleeve 202 and the vibrational work piece 214 have moved, the piston 204 is centered within the hollow control sleeve 202 as shown in FIG. 4.

In FIG. 6, the force of the motor driven worm gear 218 on the actuating rod 221 fixed to the piston 204 is less than the force of the spring 213 on the opposite end of the piston 204, establishing a position set point of the vibrational work piece 214 through the piston 204. The piston 204 is moved to the right in the figure. The movement of the piston 204 causes fluid to circulate from the first fluid chamber 216a to the second fluid chamber 216b, moving the control sleeve 202, resulting in the piston 204 being moved back to a centered position within the control sleeve 202 as shown in FIG. 4, obtaining the position set point and moving the vibrational work piece 214 in the direction of arrow 220 to a new position. Prior to the piston 204 recentering, the first piston passage 208 is open to the third fluid chamber 216c, the second piston passage 210 is blocked by the inner circumference 202a of the hollow sleeve 202, and the central piston passage 209 is open to the third fluid chamber 216c. Fluid in the first fluid chamber 216a, due to the movement and position of the piston 204 flows from the first fluid chamber 216a through the first passage 221a in the actuating rod 221 through the bore 207 to the first piston passage 208. From the first piston passage 208, fluid moves into the third fluid chamber 216c and into the central piston passage 209. From the central piston passage 209, fluid moves into the bore 207 and through check valve 206 to the second fluid chamber 216b through second passage 221b of the actuating rod 221. The movement of the fluid from the first fluid chamber 216a to the second fluid chamber 216b moves the control sleeve 202, and thus the vibrational work piece 214 in the direction of arrow 220 to a new position relative to the stationary work piece 203, following the position of the piston 204 and amplifying the force generated by the worm gear 218 and the motor 219. Once the control sleeve 202 and the vibrational work piece 214 have moved, the piston 204 is centered within the hollow control sleeve 202 as shown in FIG. 4.

While the piston was described as returning to a centered position as shown in FIGS. 1 and 4, other positions may also be established as the returning position.

The positioner of the above embodiments may also be used for variable cam timing systems or variable valve timing.

The vibrational work piece may be any piece in the engine that experiences vibrations.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A positioner comprising:
a sleeve coupled to a stationary piece having a chamber for slidably receiving a control sleeve;
a piston slidably received within the control sleeve having an end fixed to an extension piece in contact with a vibrational work piece for receiving oscillatory vibrations from the vibrational work piece on the piston, the piston and the control sleeve separating the chamber of the sleeve into a first chamber and a second chamber;
a spring linking the piston to the control sleeve; and
at least one check valve between the first chamber and the second chamber within the piston for blocking reverse fluid flow;
wherein when the oscillatory vibrations of the vibrational work piece are received by the extension piece of the piston, a position set point is set, moving the piston and selectively directed fluid flow from the first chamber to the second chamber and vice versa through the piston;
wherein the movement of the piston pressurizes the first chamber or the second chamber to recirculate fluid from the first chamber or the second chamber to the other chamber, the control sleeve following the piston through the spring linking the piston to the control sleeve, such that the piston is centered within the control sleeve, obtaining the position set point and moving the vibrational work piece relative to the stationary piece.

2. The positioner of claim 1, further comprising a spring within the first chamber or the second chamber between the housing and the control sleeve.

3. The positioner of claim 1, wherein the vibrational work piece is a tensioner arm.

4. The positioner of claim 1, wherein the stationary work piece is part of the engine.

5. The positioner of claim 1, wherein when the piston is centered within the control sleeve fluid is prevented from recirculating from the first chamber to the second chamber or vice versa.

6. A positioner comprising:
a control sleeve coupled to a vibrational work piece and having a chamber, for slidably receiving a piston;
an actuating rod being linearly moveable and having a first end fixed to the piston and a second end coupled to an external means, wherein the piston and the actuating rod separate the chamber into a first chamber and a second chamber, wherein the external means provides a position to the actuating rod, setting a position set point, moving the piston and selectively directed fluid flow from the first chamber to the second chamber and vice versa through the piston; and
at least one check valve between the first chamber and the second chamber within the piston for blocking reverse fluid flow;
wherein the movement of the piston pressurizes the first chamber or the second chamber to recirculate fluid from the first chamber or the second chamber to the other chamber, the control sleeve following the piston, such that the piston is centered within the control sleeve, obtaining the position set point and moving the vibrational work piece relative to the stationary piece.

7. The positioner of claim 6, wherein the external means is a motor driven worm gear, a vacuum source, a small electric actuator, or a solenoid.

8. The positioner of claim 6, wherein when the piston is centered within the control sleeve, fluid is prevented from recirculating from the first chamber to the second chamber or vice versa.

9. The positioner of claim 6, wherein the vibrational work piece is a piece of the engine that vibrates.

10. The positioner of claim 6, wherein the stationary work piece is part of the engine.
